(19) United States
(12) Patent Application Publication
(10) Pub. No.: US 2026/0160667 A1
(43) Pub. Date: Jun. 11, 2026

(54) Friction resistance testing device for side wall of pipe jacking machine

(71) Applicants: Zhengzhou University, Zhengzhou (CN); BeSTDR Infrastructure Hospital(Pingyu), Zhumadian (CN)

(72) Inventors: Xiaolong Li, Zhengzhou City (CN); Yanhui Zhong, Zhengzhou City (CN); Bei Zhang, Zhengzhou City (CN); Ming Guo, Zhengzhou City (CN); Pengchao Li, Zhengzhou City (CN); Lei Feng, Zhumadian (CN); Xiaofeng Liu, Zhengzhou City (CN)

(21) Appl. No.: 19/180,084

(22) Filed: Apr. 15, 2025

(30) Foreign Application Priority Data
Jul. 2, 2024 (CN) 202410876733.5

(51) Int. Cl. G01N 19/02

(52) U.S. Cl. CPC G01N 19/02

(57) ABSTRACT

A friction resistance testing device for a side wall of a pipe jacking machine includes: a shell, a pressure gauge unit, a pulley (3) and a sensing block (4); wherein the pressure gauge unit, the pulley (3) and the sensing block (4) are provided in the shell (1); the pressure gauge unit is fixed to the shell (1); the pulley (3) is provided between the sensing block (4) and the pressure gauge unit; the sensing block (4) presses the pressure gauge unit in a horizontal direction to measure a side wall friction resistance; and the sensing block (4) presses the pressure gauge unit in a vertical direction to measure a soil pressure. The present invention further provides a method for adopting the friction resistance testing device for the side wall of the pipe jacking machine.

### CROSS REFERENCE OF RELATED APPLICATION

The present application claims priority under 35 U.S.C. 119(a-d) to CN202410876733.5, filed Jul. 2, 2024.

### BACKGROUND OF THE PRESENT INVENTION

### Field of Invention

The present invention relates to the technical field of a resistance testing device for pipe jacking machine, and more particularly to a friction resistance testing device for a side wall of a pipe jacking machine.

### Description of Related Arts

As a trenchless construction method, rectangular pipe jacking method has been widely applied in the construction of municipal facilities such as underground integrated pipe corridors, underground passages, railway stations, and multi-level roads. It has the advantages of high space utilization, good economy, and good environmental protection. In sensitive areas such as transportation hubs or surface structure clusters, jacking technology is increasingly required to achieve longer jacking distances, larger jacking cross-sectional areas, and greater burial depths. During the jacking process, for safety reasons, the jacking pressure applied to the pipe section must be limited to the maximum allowable compressive strength of the jacked pipe segment, which determines the maximum jacking force under actual construction conditions. The jacking force is mainly utilized to overcome the accumulation of interface friction resistance between pipes and the surface resistance of the excavation area during jacking construction, among which friction resistance is the key factor in consuming jacking force. Therefore, accurately and timely measuring the side wall friction of the pipe jacking machine during jacking construction is of great significance to avoid pipeline damage during long-distance rectangular pipe jacking.

In the conventional arts, the friction resistance of the pipe jacking machine is usually calculated by subtracting the surface resistance of the pipe jacking machine from the total thrust of the jack. The surface resistance of the pipe jacking machine is obtained by installing a pressure gauge in front of the cutter head of the pipe jacking machine to measure the local soil pressure, and then calculating the overall surface resistance. The friction resistance of the pipe jacking machine side wall obtained by this method is obtained through indirect calculation, which has a certain lag, and the accuracy thereof depends to a large extent on the choice of calculation model, and it is not possible to obtain the value of the friction resistance of the pipe jacking machine side wall in a timely and intuitive manner during the pipe jacking construction process. A Chinese patent with an application number of CN201810931707.2 discloses a method for testing the pipe-soil contact pressure of a rectangular pipe jacking construction on a large-section of a comprehensive pipe gallery, wherein the pipe-soil contact pressure during the pipe jacking construction process is tested by actual measurement.

### SUMMARY OF THE PRESENT INVENTION

In order to solve the technical problems existing in the conventional art, the present invention provides a friction resistance testing device for a side wall of a pipe jacking machine.

In order to achieve the above-mentioned purpose, the present invention provides a friction resistance testing device for a side wall of a pipe jacking machine comprising: a shell, a pressure gauge unit, a pulley and a sensing block; wherein the pressure gauge unit, the pulley and the sensing block are provided in the shell; the pressure gauge unit is fixed to the shell; the pulley is provided between the sensing block and the pressure gauge unit; the sensing block presses the pressure gauge unit in a horizontal direction to measure a side wall friction resistance; and the sensing block presses the pressure gauge unit in a vertical direction to measure a soil pressure. The sensing block is set up to sense the friction between the soil and the side wall of the pipe jacking machine, and the vertical soil pressure of the soil can also be sensed at the same time; the pulley is provided between the sensing block and the pressure gauge unit, so that the sensing block can slide slightly in the horizontal direction, and the pressure gauge unit can sense the vertical soil pressure. The device has the characteristics of simple structure, convenient operation, economical and practical, and high construction efficiency, and is capable of ensuring the accurate perception of the side wall friction during the construction of the pipe jacking machine.

Preferably, in the friction resistance testing device for the side wall of the pipe jacking machine provided by the present invention, the pressure gauge unit comprises a horizontal pressure sensing gauge and a vertical pressure sensing gauge; the horizontal pressure sensing gauge is vertically fixed on the shell, and the horizontal pressure sensing gauge is provided on the side surface of the sensing block; the vertical pressure sensing gauge is horizontally fixed on the shell, and the vertical pressure sensing gauge is provided below the sensing block, so as to test a vertical pressure. When the pipe jacking machine moves, the sensing block squeezes the horizontal sensing pressure gauge in the horizontal direction to measure the side wall friction resistance, and the sensing block squeezes the vertical sensing pressure gauge in the vertical direction to measure the soil pressure.

Preferably, the friction resistance testing device for the side wall of the pipe jacking machine provided by the present invention, further comprises a plurality of backing plates which are provided on a surface of the horizontal sensing pressure gauge close to the sensing block, and on a surface of the vertical sensing pressure gauge close to the sensing block. The backing plate is provided on the surface of the pressure gauge unit, that is, the surface of the horizontal sensing pressure gauge and the vertical sensing pressure gauge close to the sensing block is covered with a pad to ensure that the pressure gauge unit is evenly stressed.

Preferably, in the friction resistance testing device for the side wall of the pipe jacking machine provided by the present invention, a rubber pad is provided between the sensing block and the backing plate of the horizontal pressure sensing gauge. The rubber pad is installed between the pad and the sensing block of the horizontal sensing pressure gauge, which can play a buffering and resetting role for the sensing block.

Preferably, in the friction resistance testing device for the side wall of the pipe jacking machine provided by the present invention, the pulley is provided between the sensing block and the backing plate of the vertical pressure sensing gauge, and a sliding direction of the pulley is consistent with a surface normal direction of the horizontal pressure sensing gauge. The pulley is installed between the sensing block and the vertical sensing pressure gauge pad, thereby allowing the sensing block to produce a slight sliding in the horizontal direction and ensuring that the vertical sensing pressure gauge is only responsible for sensing the vertical soil pressure.

Furthermore, the present invention provides a method for adopting the friction resistance testing device for the side wall of the pipe jacking machine, comprising steps of: installing the friction resistance testing device for the side wall of the pipe jacking machine in a groove on a side wall of the pipe jacking machine, turning on a switch of the pipe jacking machine, and driving the sensing block to move in an opposite direction to an excavation direction of the pipe jacking machine, so that the sensing block squeezes the horizontal pressure sensing gauge to measure the friction resistance, of the side wall; and a weight of soil buried above the pipe jacking machine causes the sensing block to move downward, squeezing the vertical pressure sensing gauge to measure the soil pressure on the side wall above the pipe jacking machine.

Compared with the prior art, the technical solution of the present invention has the following beneficial effects:
Firstly, the friction resistance testing device for the side wall of the pipe jacking machine provided by the present invention comprising: a shell, a pressure gauge unit, a pulley and a sensing block; wherein the pressure gauge unit, the pulley and the sensing block are provided in the shell; the pressure gauge unit is fixed to the shell; the pulley is provided between the sensing block and the pressure gauge unit; the sensing block presses the pressure gauge unit in a horizontal direction to measure a side wall friction resistance; and the sensing block presses the pressure gauge unit in a vertical direction to measure a soil pressure. The sensing block is set up to sense the friction between the soil and the side wall of the pipe jacking machine, and the vertical soil pressure of the soil can also be sensed at the same time; the pulley is provided between the sensing block and the pressure gauge unit, so that the sensing block can slide slightly in the horizontal direction, and the pressure gauge unit can sense the vertical soil pressure. The device has the characteristics of simple structure, convenient operation, economical and practical, and high construction efficiency, and is capable of ensuring the accurate perception of the side wall friction during the construction of the pipe jacking machine.
Secondly, in the side wall friction resistance test device of the pipe jacking machine provided by the present invention, in the friction resistance testing device for the side wall of the pipe jacking machine provided by the present invention, the pressure gauge unit comprises a horizontal pressure sensing gauge and a vertical pressure sensing gauge; the horizontal pressure sensing gauge is vertically fixed on the shell, and the horizontal pressure sensing gauge is provided on the side surface of the sensing block; the vertical pressure sensing gauge is horizontally fixed on the shell, and the vertical pressure sensing gauge is provided below the sensing block, so as to test a vertical pressure. When the pipe jacking machine moves, the sensing block squeezes the horizontal sensing pressure gauge in the horizontal direction to measure the side wall friction resistance, and the sensing block squeezes the vertical sensing pressure gauge in the vertical direction to measure the soil pressure.
Thirdly, in the friction resistance testing device for the side wall of the pipe jacking machine provided by the present invention, the pulley is provided between the sensing block and the backing plate of the vertical pressure sensing gauge, and a sliding direction of the pulley is consistent with a surface normal direction of the horizontal pressure sensing gauge. The pulley is installed between the sensing block and the vertical sensing pressure gauge pad, thereby allowing the sensing block to produce a slight sliding in the horizontal direction and ensuring that the vertical sensing pressure gauge is only responsible for sensing the vertical soil pressure.

### BRIEF DESCRIPTION OF THE DRAWINGS

In order to more clearly illustrate the technical solutions in the embodiments of the present invention or the conventional arts, the drawings required for use in the embodiments or the conventional arts description will be briefly introduced below. Obviously, the drawings described below are only some embodiments of the present invention. For ordinary technicians in this field, other drawings can be obtained based on the structures shown in these drawings without creative work.

FIG. 1 is a structural schematic diagram of a side wall friction resistance test device of the pipe jacking machine according to a preferred embodiment of the present invention;

FIG. 2 is a schematic diagram of the installation position of the side wall friction resistance test device of the pipe jacking machine according to a preferred embodiment of the present invention.

### REFERENCE NUMBERS IN THE DRAWINGS

1—shell; 21—horizontal pressure sensing gauge; 22—vertical pressure sensing gauge; 3—pulley; 4—sensing block; 5—backing plate; 6—rubber pad; 7—pipe jacking machine.

### DETAILED DESCRIPTION OF THE PREFERRED EMBODIMENT

The following will be combined with the drawings in the embodiments of the present invention to clearly and completely describe the technical solutions in the embodiments of the present invention. Obviously, the described embodiments are only part of the embodiments of the present invention, not all of the embodiments. Based on the embodiments in the present invention, all other embodiments obtained by ordinary technicians in this field without creative work are within the scope of protection of the present invention.

It should be noted that all directional indications in the embodiments of the present invention, such as first, second, up, down, left, right, front, back, etc., are only used to explain the relative position relationship and movement of the components under a certain specific posture as shown in the drawings. If the specific posture changes, the directional indication will also change accordingly.

In addition, the technical solutions between the various embodiments of the present invention can be combined with each other, but it must be based on the ability of ordinary technicians in this field to achieve it. When the combination of technical solutions is contradictory or cannot be achieved, it should be considered that such a combination of technical solutions does not exist and is not within the scope of protection required by the present invention.

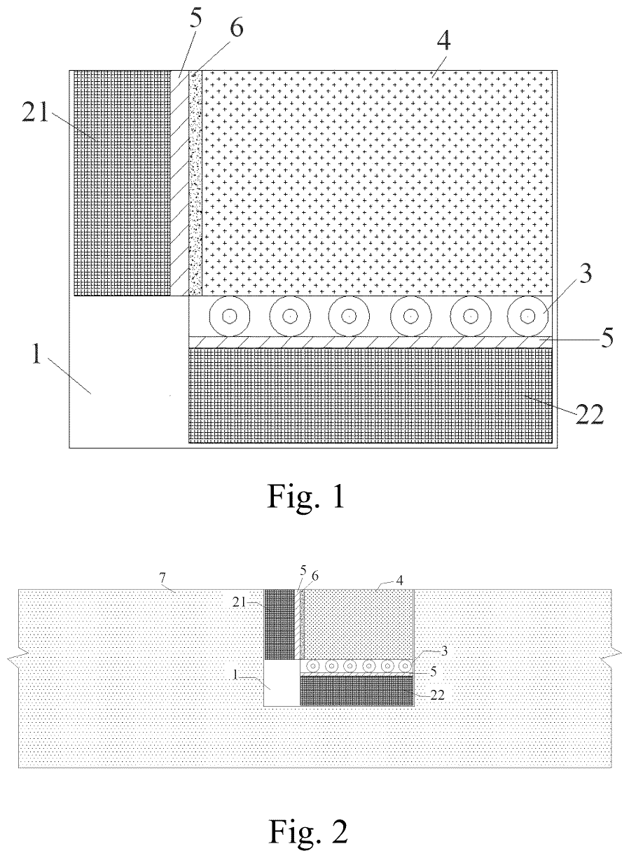

Referring to FIG. 1 and FIG. 2, the present invention provides a friction resistance testing device for a side wall of a pipe jacking machine comprising: a shell 1, a pressure gauge unit, a pulley 3 and a sensing block 4; wherein the pressure gauge unit, the pulley 3 and the sensing block 4 are provided in the shell 1; the pressure gauge unit is fixed to the shell 1; the pulley 3 is provided between the sensing block 4 and the pressure gauge unit; the sensing block 4 presses the pressure gauge unit in a horizontal direction to measure a side wall friction resistance; and the sensing block 4 presses the pressure gauge unit in a vertical direction to measure a soil pressure. The sensing block 4 is set up to sense the friction resistance between the soil and the side wall of the pipe jacking machine 7, and the vertical soil pressure of the soil can also be sensed at the same time; the pulley 3 is provided between the sensing block 4 and the pressure gauge unit, so that the sensing block 4 can slide slightly in the horizontal direction, and the pressure gauge unit can sense the vertical soil pressure. The device has the characteristics of simple structure, convenient operation, economical and practical, and high construction efficiency, and is capable of ensuring the accurate perception of the side wall friction during the construction of the pipe jacking machine 7.

Referring to FIG. 1, in the friction resistance testing device for the side wall of the pipe jacking machine provided by the present invention, the pressure gauge unit comprises a horizontal pressure sensing gauge 21 and a vertical pressure sensing gauge 22; the horizontal pressure sensing gauge 21 is vertically fixed on the shell 1, and the horizontal pressure sensing gauge 21 is provided on the side surface of the sensing block 4; the vertical pressure sensing gauge 22 is horizontally fixed on the shell 1, and the vertical pressure sensing gauge 22 is provided below the sensing block 4, so as to test a vertical pressure. When the pipe jacking machine 7 moves, the sensing block 4 squeezes the horizontal pressure sensing gauge 21 in the horizontal direction to measure the side wall friction resistance, and the sensing block 4 squeezes the vertical pressure sensing gauge 22 in the vertical direction to measure the soil pressure.

Furthermore, the friction resistance testing device for the side wall of the pipe jacking machine provided by the present invention, further comprises a plurality of backing plates 5 which are provided on a surface of the horizontal sensing pressure gauge 21 close to the sensing block 4, and on a surface of the vertical sensing pressure gauge 22 close to the sensing block 4. The backing plate is provided on the surface of the pressure gauge, that is, the surface of the horizontal sensing pressure gauge and the vertical sensing pressure gauge close to the sensing block is covered with a pad to ensure that the pressure gauge is evenly stressed.

Furthermore, in the friction resistance testing device for the side wall of the pipe jacking machine provided by the present invention, wherein a rubber pad 6 is provided between the sensing block 4 and the backing plate 5 of the horizontal pressure sensing gauge 21, i.e. the rubber pad 6 is installed between the backing plate 5 and the sensing block 4 of the horizontal pressure sensing gauge 21, which can play a buffering and resetting role for the sensing block 4.

Furthermore, in the friction resistance testing device for the side wall of the pipe jacking machine provided by the present invention, the pulley 3 is provided between the sensing block 4 and the backing plate 5 of the vertical pressure sensing gauge 22, and a sliding direction of the pulley 3 is consistent with a surface normal direction of the horizontal pressure sensing gauge 21. The pulley 3 is installed between the sensing block 4 and the vertical pressure sensing gauge 22 and the backing plate 5, thereby allowing the sensing block 4 to produce a slight sliding in the horizontal direction and ensuring that the vertical pressure sensing gauge 22 is only responsible for sensing the vertical soil pressure.

Referring to FIG. 2, in the friction resistance testing device for the side wall of the pipe jacking machine provided by the present invention, the shell 1 is configured to be installed in a groove on the side wall of the pipe jacking machine 7, and a top of the sensing block 4 is maintained at an identical height with the outside of the pipe jacking machine 7.

Furthermore, the present invention provides a method for adopting the friction resistance testing device for the side wall of the pipe jacking machine, comprising steps of: installing the friction resistance testing device for the side wall of the pipe jacking machine in a groove on a side wall of the pipe jacking machine 7, turning on a switch of the pipe jacking machine 7, and driving the sensing block 4 to move in an opposite direction to an excavation direction of the pipe jacking machine 7, so that the sensing block 4 squeezes the horizontal pressure sensing gauge 21 to measure the friction resistance, of the side wall; and a weight of soil buried above the pipe jacking machine 7 causes the sensing block 4 to move downward, squeezing the vertical pressure sensing gauge 22 to measure the soil pressure on the side wall above the pipe jacking machine 7.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A friction resistance testing device for a side wall of a pipe jacking machine comprising: a shell (1), a pressure gauge unit, a pulley (3) and a sensing block (4); wherein the pressure gauge unit, the pulley (3) and the sensing block (4) are provided in the shell (1); the pressure gauge unit is fixed to the shell (1); the pulley (3) is provided between the sensing block (4) and the pressure gauge unit; the sensing block (4) presses the pressure gauge unit in a horizontal direction to measure a side wall friction resistance; and the sensing block (4) presses the pressure gauge unit in a vertical direction to measure a soil pressure.

2. The friction resistance testing device for the side wall of the pipe jacking machine, as recited in claim 1, wherein the pressure gauge unit comprises a horizontal pressure sensing gauge (21) and a vertical pressure sensing gauge (22); the horizontal pressure sensing gauge (21) is vertically fixed on the shell (1), and the horizontal pressure sensing gauge (21) is provided on the side surface of the sensing block (4); the vertical pressure sensing gauge (22) is horizontally fixed on the shell (1), and the vertical pressure sensing gauge (22) is provided below the sensing block (4).

3. The friction resistance testing device for the side wall of the pipe jacking machine, as recited in claim 2, further comprising a plurality of backing plates (5) which are provided on a surface of the horizontal sensing pressure gauge (21) close to the sensing block (4), and on a surface of the vertical sensing pressure gauge (22) close to the sensing block (4).

4. The friction resistance testing device for the side wall of the pipe jacking machine, as recited in claim 3, wherein a rubber pad (6) is provided between the sensing block (4) and the backing plate (5) of the horizontal pressure sensing gauge (21).

5. The friction resistance testing device for the side wall of the pipe jacking machine, as recited in claim 3, wherein the pulley (3) is provided between the sensing block (4) and the backing plate (5) of the vertical pressure sensing gauge (22), and a sliding direction of the pulley (3) is consistent with a surface normal direction of the horizontal pressure sensing gauge (21).

6. A method for adopting the friction resistance testing device for the side wall of the pipe jacking machine, as recited in claim 1, comprising: installing the friction resistance testing device for the side wall of the pipe jacking machine in a groove on a side wall of the pipe jacking machine (7), turning on a switch of the pipe jacking machine (7), and driving the sensing block (4) to move in an opposite direction to an excavation direction of the pipe jacking machine (7), so that the sensing block (4) squeezes the horizontal pressure sensing gauge (21) to measure the friction resistance, of the side wall; and a weight of soil buried above the pipe jacking machine (7) causes the sensing block (4) to move downward, squeezing the vertical pressure sensing gauge (22) to measure the soil pressure on the side wall above the pipe jacking machine (7).
Friction resistance testing device for side wall of pipe jacking machine
